(19) United States
(12) Patent Application Publication
(10) Pub. No.: US 2014/0333508 A1
(43) Pub. Date: Nov. 13, 2014

(54) SYSTEM AND METHOD FOR COMMUNICATING AND INTERACTING WITH A DISPLAY SCREEN USING A REMOTE DEVICE

(71) Applicants: Michael Jay Yuann, San Francisco, CA (US); Jisheng Deng, Shanghai (CN)

(72) Inventors: Michael Jay Yuann, San Francisco, CA (US); Jisheng Deng, Shanghai (CN)

(73) Assignee: GAME CONCOURSE INC., San Francisco, CA (US)

(21) Appl. No.: 14/017,204

(22) Filed: Sep. 3, 2013

Related U.S. Application Data
(60) Provisional application No. 61/696,082, filed on Aug. 31, 2012.

(51) Int. Cl. G09G 5/00; G06K 7/10; G06F 3/14

(52) U.S. Cl. CPC G09G 5/003; G06F 3/1407; G06K 7/10861; G09G 2370/022; G09G 2380/06; G09G 2370/042; G09G 2370/16
USPC 345/2.1

(57) ABSTRACT

An interactive system involving network-connected display devices and remote devices. Content is transferred to a display device and controlled by one or more remote devices linked to the display device through a network. Communication between the display device and the one or more remote devices is established through a communication server by using coded identifiers associated with the display device. The identifiers may be embedded within quick response (QR) codes or URLs scanned by or otherwise input to the remote devices. The remote devices may interact with and control content presented by the display device through communications relayed through the server.

### CROSS-REFERENCE TO RELATED APPLICATIONS

The present application claims the benefit of U.S. Provisional Application No. 61/696,082, entitled “System and Method for Communication and Controlling Content on a Display Screen with Remote Devices”, filed Aug. 31, 2012, which is incorporated herein by reference in its entirety for all purposes.

### FIELD

The present disclosure relates to the field of media displays such as may be used for content presentation, distribution and advertising. More particularly, but not exclusively, the disclosure relates to methods for interacting with such displays.

### BACKGROUND

Dynamic video displays are becoming increasingly common in public areas, disseminating information to passing individuals, and are often used for content presentation, distribution, and advertising. Due to their dynamic nature, such displays are substituting and complementing traditional forms of content distribution, such as posters, billboards, and flyers. As underlying hardware for such displays has improved, these displays may now establish direct connections to the Internet, opening a new set of interaction possibilities, beyond non-interactive forms of video and static content.

Interactivity between display screens and personal remote devices has been limited by methods to establish communication between the displays and remote devices. Traditionally, setting network connections between multiple devices require varied procedures in modifying system level configurations. Common methods involve a series of steps, including identifying and selecting the desired network, and inputting configuration information, which may include pairing codes or passwords, before a connection is established. Consequently, network set up procedures often interfere with enabling remote devices to communicate with a screen.

Many users now regularly carry mobile devices, such as smart phones and tablet computers. As the computing power for such devices has increased, today's devices are capable of handling increasingly complex programs and tasks, by using and enabling a variety of hardware, including color display, camera, speakers, network interfaces, environmental sensors (such as GPS, gyrometer, and accelerometer), and input mechanisms such as buttons and touch screens.

Quick Response (QR) codes have become a common means for disseminating information to mobile devices. These codes often embed a URL conforming to an Internet address, where mobile device content and applications can be executed. The emergence of image scanning methods for retrieving content via the mobile Internet, and the popularity of dynamic media displays and mobile devices, provides context for the invention.

### SUMMARY

In one aspect the disclosure pertains to a method of establishing a communication channel between a display device and at least one remote device. The method includes receiving, at a server, a registration request sent by a display device. The method further includes sending, in response to the registration request, a pairing code to the display device. A connection request including the pairing code is received from a remote device. The method further includes associating, based upon the pairing code, the display device and the remote device. A first notification is sent to the display device and a second notification is sent to the remote device. The first notification and the second notification indicate that the communication channel has been established.

### BRIEF DESCRIPTION OF THE DRAWINGS

For a better understanding of the nature and objects of various embodiments disclosed herein, reference should be made to the following detailed description taken in conjunction with the accompanying drawings, wherein:

FIG. 1 provides a simplified illustration of an exemplary architecture of a system in which may be implemented embodiments of the present disclosure.

FIG. 2 illustratively represents an exemplary method for enabling communication between a display device and a remote device from an end user perspective.

FIG. 3 illustrates additional details of a typical configuration of a remote device with example device elements that may be used to implement embodiments of the systems and methods in accordance with the disclosure.

FIG. 4 illustrates additional details of one example of a server with example device elements that may be used to implement embodiments of the present disclosure.

FIG. 5 is a logic sequence diagram with detailed methods for allowing initial operation of an exemplary remotely interactive display system.

FIGS. 6A-6D collectively illustrate aspects of a touch-activated remote control presentation and photo viewer application implemented by the remotely interactive display system of the disclosure.

FIGS. 7A-7E collectively illustrate aspects of a motion-controlled game application implemented by the remotely interactive display system of the disclosure.

FIGS. 8A-8D collectively illustrate aspects of a motion-activated remote control 3D model viewer application implemented by the remotely interactive display system of the disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

### Introduction

The present disclosure relates to a system and method for enabling interactivity between a media display and one or more remote devices by way of a communications server in network communication with the media display and remote devices.

In one aspect the disclosure pertains to a display device including a computing unit capable of executing a standard Web browser application or other specialized application to establish a network connection to a server using standard Internet protocols. The server may generate a unique ID, also referred to hereinafter as a pairing code, based on, for example, the time the connection is established or a pairing request is made. The server may send the pairing code, in addition to application content and logic, to the display device. During operation the display device may interpret the application content and logic and may, for example, embed the pairing code as a uniform resource locator (URL). In this case the display device may render, on its screen, the URL as a human-readable text string or a URL-encoded QR code. In other implementations information identifying the pairing code such as, for example a URL-encoded QR code, is displayed upon printed signage or other media positioned in the vicinity of the display device.

In another aspect, a remote device may scan a QR code displayed on the display device and utilize QR decoding software to extract the URL from the QR code. In other implementations standard user input methods are employed to input a human-readable text string displayed on the display device and containing the URL into a web browser executed by the remote device. The remote device may establish a network connection to the server and send the pairing code extracted from the URL to the server. In this way an Internet-relayed communication channel to the display device is effectively requested.

In another aspect the server may then send a message to the display device providing a notification that a communication channel has been established with the remote device. The display device may then identify the channel as connected and perform one or more actions. For example, the display device may cease displaying the QR code and text string from the display and instead display a screen controllable by a user of the remote device. Alternatively, the display device may continue displaying pairing code or request a new unique pairing code from the server to permit the above procedure to be repeated by a user of another remote device. At this point the display device and the remote device are able to conduct two-way communication by, for example, sending application-level messages relayed by server. Multiple remote devices may join into the communication network established by the server by repeating the procedure above. Moreover, any capable device already in the established network may also act as additional display devices.

In another aspect the server may provide receive a registration request from a display device and responsively issue a pairing code to the display device. The server may also receive a connection request from a remote device with the pairing code given to the display device and use the pairing code to associate the display device and the remote device. In addition, the server may provide notification to both the display device and the remote device that a communication channel has been established. In certain implementations if a connection between a display device and the server is broken or otherwise interrupted, the remote device and potentially other devices in the communication network facilitated by the server are notified. Similarly, if a connection between a remote device and the server is broken or otherwise interrupted, the display device and potentially other remote devices in the communication network facilitated by the server may be notified.

### Exemplary System Architecture

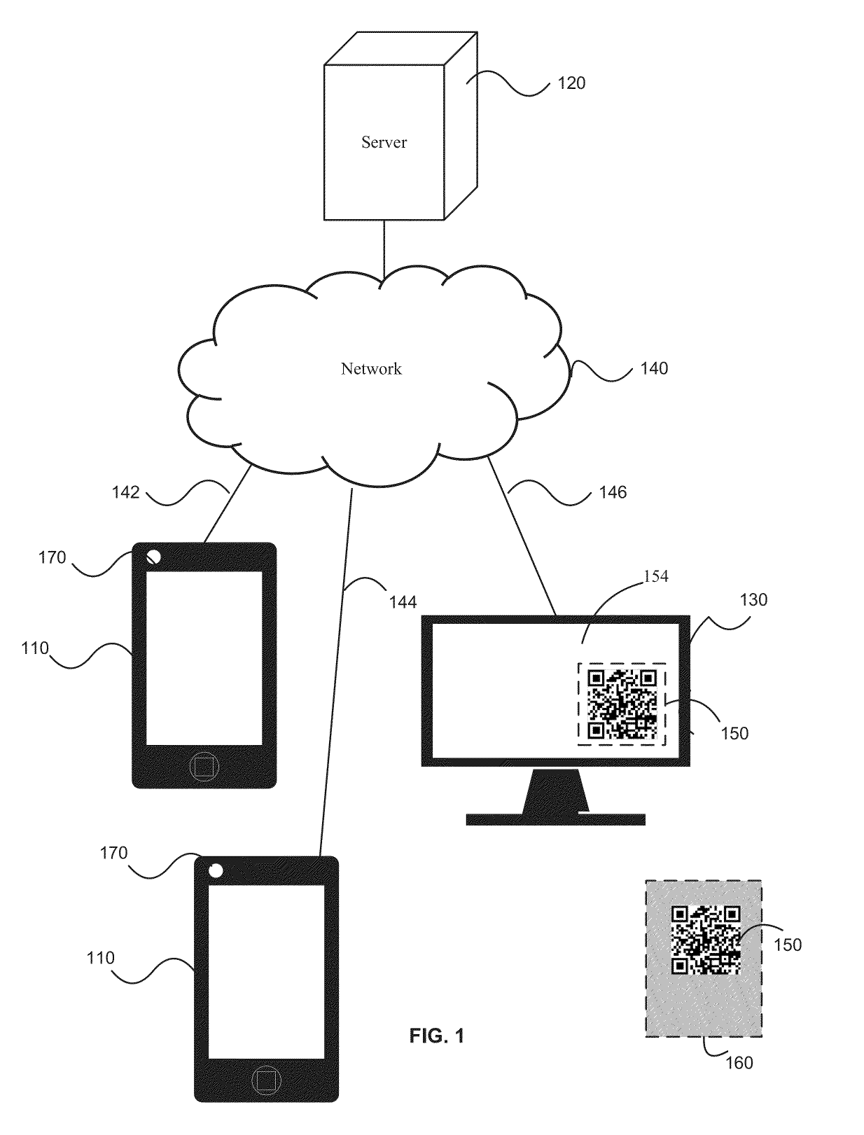

Attention is now directed to FIG. 1, which provides a simplified illustration of an exemplary architecture of a system 100 in which may be implemented embodiments of the present disclosure. The system 100 includes one or more remote devices 110, a server 120 and a display device 130. As is discussed below, communication between the remote devices 110 and display device 130 may occur over a network 140 by way of the server 120. In this regard the server 120 may be considered to be a remote network service endpoint connected to the network 140, which may be one or more of wired networks, wireless networks, the Internet, and other network types over which communication can occur. The network 140 supports communication channels 142, 144, 146 through which the remote devices 110 and the display device 130 and may be connected via the server 120.

The display device 130 is typically comprised of a computing unit and an element capable of providing a dynamic display output, such as an LED or LCD screen. For the reasons described hereinafter, the display device 130 may generate and display a unique coded identifier or “pairing code” 150 used in establishing communication between the remote devices 110 and the display device 130. Typically, the display device 130 may generate and display the pairing code 150 for rendering on a screen 154 of the display device 130. However, in other embodiments the pairing code may be printed on physical media 160, which will typically be positioned in the vicinity of the display device 130. The one or more remote devices 110 may comprise a smart phone or tablet computer, and may include a camera 170 for recognition and processing of the pairing code 150, or other means of input for the device to communicate with the server 120.

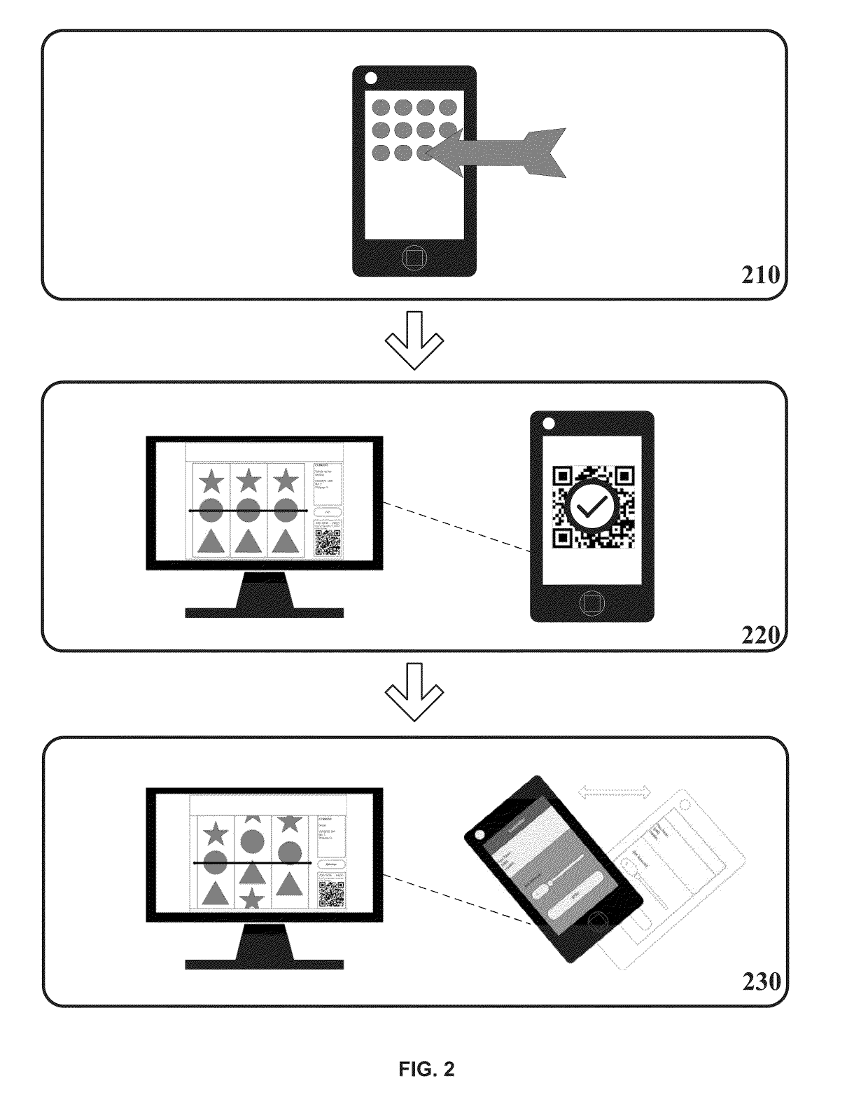

FIG. 2 illustratively represents an exemplary method for enabling communication between the display device 130 and a remote device 110 from an end user perspective. In a first stage 210, the user invokes a QR code scanning application on the remote device 110. Next, the user uses the remote device 110 to scan the QR code 150 associated with the display (stage 220). Once the scanner interprets the embedded URL, the connection to a server is established, enabling a channel for communication and control of content on the screen 154 of the display device 130. The user may then perform an action on the remote device 110, resulting in some form of dynamic interaction with the display device 130 (stage 230).

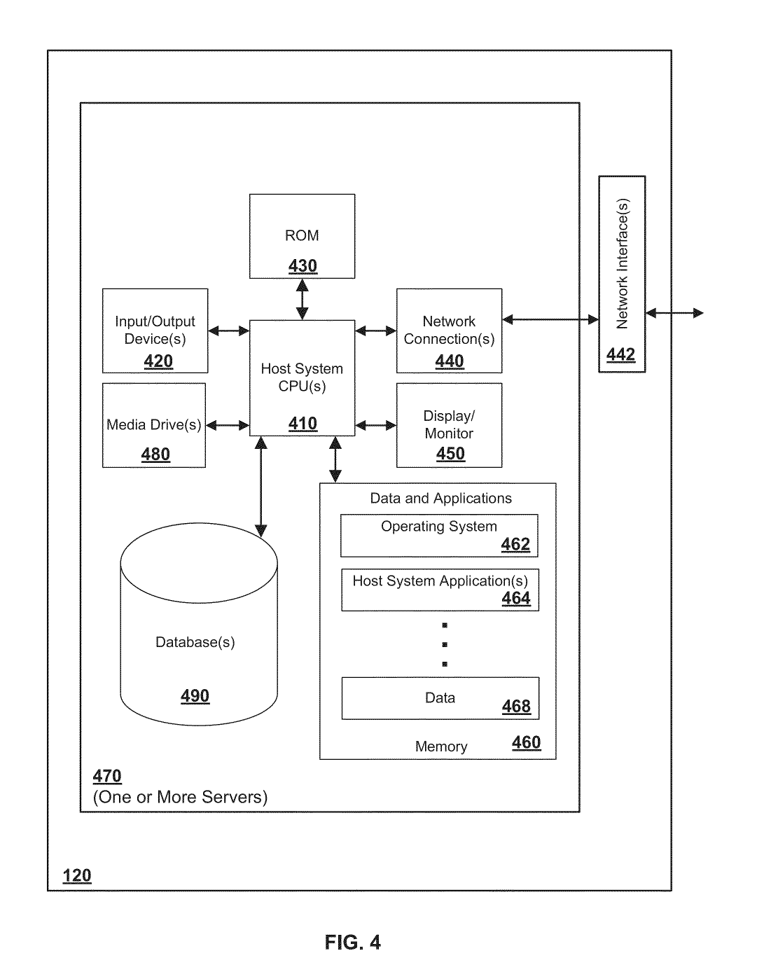

Referring again to FIG. 1, each server 120 may be comprised of one or more physical or logical servers as well as other associated computer and data processing hardware such as networking equipment, displays, monitors, I/O devices or other computer or data communication systems, hardware and/or software. In an exemplary embodiment, server 120 may be provided by or operated by an associated host services company or host services supplier. The server 120 may include one or more databases 490 (as shown in FIG. 4), either internal or external to the server 120. These databases 490 may be used to store pairing information and data such as is further described below. Server 120 may also include one or more operating systems associated with the servers, as well as one or more application programs to implement the various functionality as is described further herein. Server 120 may be implemented at a centralized physical location such as a network connected server farm or other similar facility and/or may comprise a plurality of distributed servers connected by any of a variety of networking connections at different physical locations.

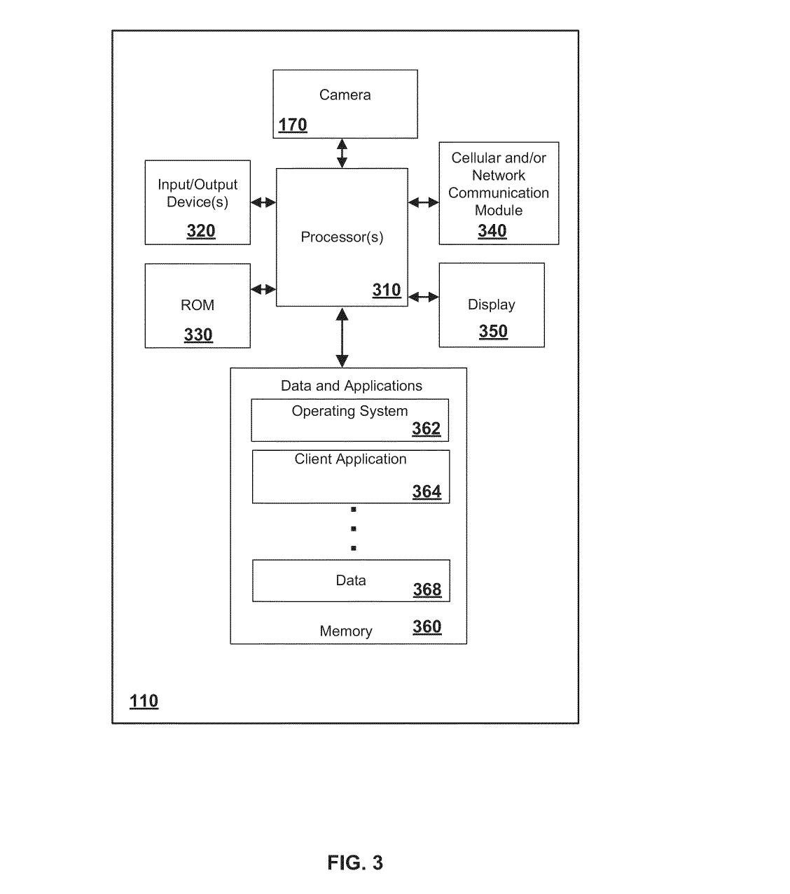

Remote devices 110 are typically configured to connect to server 120 through network 140 as shown in FIG. 1. Network 140 may include wired or wireless networking elements such as Ethernet, LAN technologies, telephony networks such as POTS phone networks, cellular networks, data networks, or other telephony networks as well as Wi-Fi or Wi-Max networks, other wired or wireless Internet network connections and/or other networks as are known or developed in the art. These connections may be facilitated by one or more client applications 364 (as shown in FIG. 3) running on remote devices 110 as well as one or more host system applications 464 running on one or more servers 120, along with one more network interfaces 442 and/or other networking hardware and/or software as is known or developed in the art (not shown).

The user may be provided with a client application or applications 364, as shown in FIG. 3 (also denoted herein as a “client” for purposes of brevity) that may be installed on the user's device 110. For example, the user may be provided with a download of the client application 364 from server 120 or affiliated web site. Once the user downloads or otherwise obtains the client application 364 and installs the client application 364 on the user's device 110, the user may then interact with the display device 130 once the server 120 has established appropriate connections through the network 140. Alternatively, in some embodiments a user of a device 110 may use a conventional Web browser instantiated on the user's device 110 in communicating with the display device 130 via the server 120.

FIG. 3 illustrates additional details of a typical configuration of a remote device 110 with example device elements that may be used to implement embodiments of the systems and methods in accordance with the disclosure. As shown in FIG. 3, device 110 may include one or more processors (CPUs) 310, which are typically one or more specialized or dedicated portable device microprocessors or microcontrollers, an input/output device module 320 configured to allow users to input and output information and interact with applications installed on the device 110, such as the client application 364, one or more read only memory (ROM) devices 330 or equivalents to provide non-volatile storage of data and/or application or operating system programs, one or more display modules 350, such as an LCD or equivalent display device, as well as one or more memory spaces 360.

Memory space 360 may comprise DRAM, SRAM, FLASH, hard disk drives or other memory storage devices configured to store and access operating systems 362, client application programs 364 and/or data 368. In particular, memory space 360 may include one or more client applications 364 stored in the memory space 360 for execution on the CPU 310 to perform the various client-side functionality described herein.

FIG. 4 illustrates additional details of one example of a server 120 with example device elements that may be used to implement embodiments of the present disclosure. As shown in FIG. 4, server 120 may include one or more processors (CPUs) 410, an input/output device module 420 configured to allow users to input and output information and interact with the server 120 as well as transfer and receive data, one or more read only memory (ROM) devices 430 or equivalents to provide non-volatile storage of data and/or programs, one or more display modules 450 such as a computer monitor or other display device, one more network connections 440 and associated network interfaces 442 configured to allow server 120 to connect to other systems, display devices, servers and/or remote devices, including other components of server 120 in embodiments where the server components are distributed at other physical locations, as well as one or more memory spaces 460 and one or more databases 490. The various components shown in FIG. 4 may be incorporated in one or more physical servers 470 comprising part of server 120. It is noted that the various components shown in FIG. 4, including database 490, are typically included as part of server(s) 470, however, they may be external to server(s) 470 in some embodiments. For example, in some embodiments database(s) 490 may be external to server(s) 470 and may comprise part of a separate database server system or networked database system.

Memory space 460 may comprise DRAM, SRAM, FLASH, hard disk drives or other memory storage devices, such as media drives 480, configured to store operating systems, application programs and/or data, and memory space 460 may be shared with, distributed with or overlap with the memory storage capacity of database 490. In some embodiments memory space 460 may include database 490 or in some embodiments database 490 may include data 468 as shown in memory space 460.

Data stored in memory space 460 and/or database 490 may include information such as images/photos, videos, or other types of data. In particular, memory space 460 may include a system application or applications 464 stored in the memory space for execution on CPU 410 to perform the various server-side functionality described herein.

### Exemplary System Operation

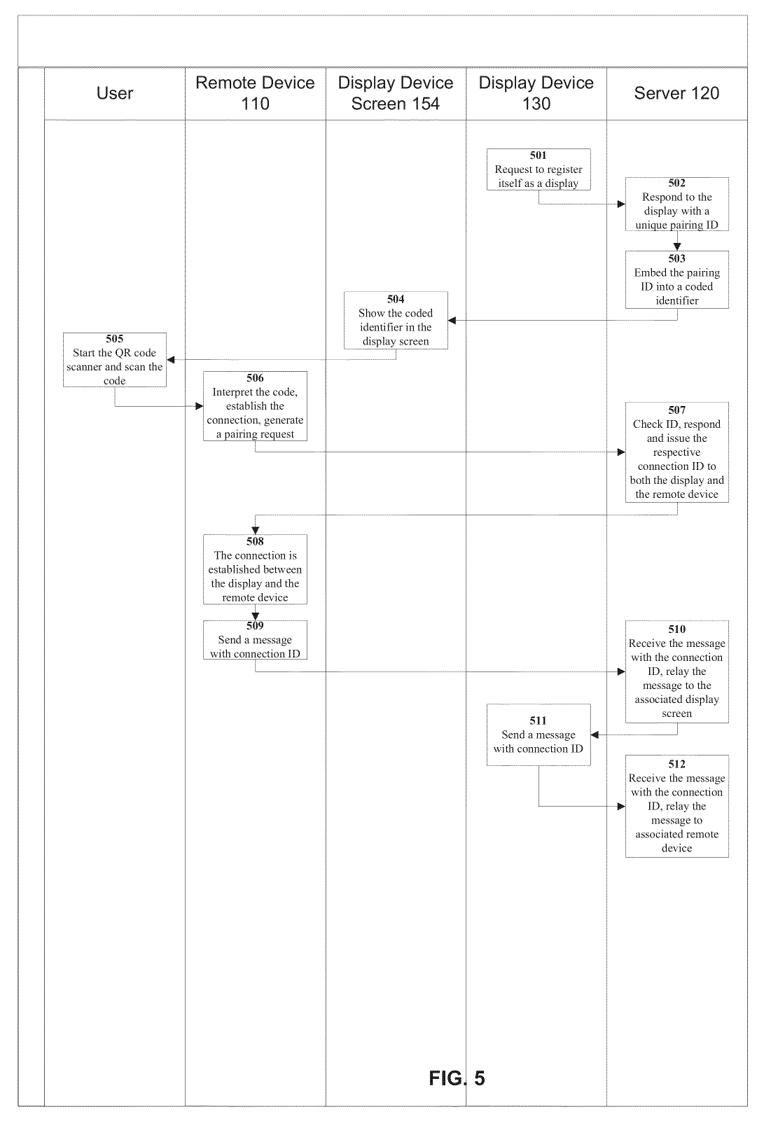

From an operating perspective, various messages are transmitted between system components to establish a communication between the display screen and remote devices. FIG. 5 is a logic sequence diagram with detailed methods for allowing initial operation of the system.

Referring to FIG. 5, in order to activate the display screen 154 the display device 130 opens a channel to the server 120 and invokes a request to register itself as a display (stage 501). The server 120 responds to the display with a unique pairing ID (stage 502). The pairing ID is then embedded into a coded identifier (such as, for example, a URL with the pairing ID) (state 503). The display screen 154 shows the coded identifier (stage 504).

To activate the remote device 110, the user starts a QR code scanner application on the device and scans the code presented by the display screen 154 or physical media 160 (stage 505). The code is interpreted as a URL, and the remote device 110 establishes a connection to the server 120, generating a pairing request from the unique identifier in the QR code (stage 506). The server 120 will check if the ID is in the registered display list. If so, the server 120 responds that the remote device 110 and display device 130 are successfully paired, and a respective connection ID is issued to both the display device 130 and the remote device 110 (stage 507).

Now that a connection has been established between the display device 130 and the remote device 110, messages sent by either entity can be relayed by the server (stage 508). For example, the remote device 110 may send a message with a connection ID (stage 509). The server 120 receives the message with the connection ID, which is associated with the display device 130 (or display screen 154), and relays the message to the associated display device 130, with or without further modification (stage 510). Alternatively, the display device 130 could send a message with a connection ID (stage 511). The server 120 receives the message with the connection ID, which is associated with the remote device 110, and relays the message to the associated remote device 110, with or without further modification (stage 512).

### Exemplary System Components

### Display Device

In one embodiment “Internet-enabled dynamic display” is abbreviated as “display device”, and refers to a physical hardware device or combination of devices with an Internet connection, that is capable of rendering Internet web pages or Internet content, and may have extended capabilities for producing sound to an external or embedded sound device. The exemplary display device(s) 130 may refer to any type of display device, including but not limited to a smart TV, LCD monitor, LED monitor, CRT monitor, interactive projector, dynamic billboard or advertising display, laptop computer, tablet device, or computer desktop with monitor. The exemplary display device(s) 130 may possess one or more of the following elements or features:
1) The exemplary display device(s) 130 may be primarily physical hardware running some software.
2) The exemplary display device(s) 130 may have an embedded display screen (e.g., LCD, LED, Plasma, CRT), or may drive a display unit (via HDMI, Component, DVI, DisplayPort, VGA, S-Video, or Composite Video ports).
3) The exemplary display device(s) 130 may have a computing unit, which may accept network communication as user input, and interpret it into application logic, which may be further described as:
   a) The device has a LAN or cellular network interface, so the device may send and receive data to and from the Internet.
   b) The device may have a TCP/IP protocol stack.
   c) The device may have a HTTP client protocol stack.
   d) The device may not need a publicly accessible network address that can be accessed from the public internet (the device may not need to accept incoming network connections or services and may be behind a firewall).
4) The exemplary display device may interpret and render HTML-formatted content through standard HTML browser software, or through software with Internet communication capabilities.
5) The exemplary display device(s) 130 may execute additional software downloaded from the Internet, which could be implemented as computer languages.
6) The exemplary display device(s) 130 may produce sound through embedded speakers, or can drive a sound device (via HDMI, composite, optical, SPDIF, ⅛ inch stereo audio out ports).

### Remote Device

In one embodiment the “independent, Internet connected device” is abbreviated as “remote device”, and may refer to any type of portable electronic devices including, but not limited to: smart phones, tablets, media devices, and laptops. The remote device(s) 110 may possess one or more of the following elements or features:
1) The exemplary remote device 110 may be a portable electronic device with Internet-capable hardware and operating system.
2) The exemplary remote device 110 may be extended with additional hardware capabilities such as display, camera, touchscreen, buttons, small keyboard/thumbpad, accelerometer, gyroscope, sound output, vibrator, GPS navigation, buttons, and/or controllable LED flash light.
3) The exemplary remote device 110 may have a computing unit, which may interpret input from its hardware components, and translate the input into software application logic.
4) The exemplary remote device 110 may, through software application logic, generate network communication, which may be further described as:
   a) The device has a LAN or cellular network interface, so it can send and receive data to and from the Internet.
   b) The device has a TCP/IP protocol stack.
   c) The device has a HTTP client protocol stack.
   d) The device does not need a publicly accessible network address that can be accessed from the public internet (it does not need to accept incoming network connections or services and may be behind a firewall).
5) The exemplary remote device 110 may interpret and render HTML-formatted content through standard HTML browser software, or through software with Internet communication capabilities.
6) The exemplary remote device 110 may execute additional software downloaded from the Internet, which may be implemented as computer languages.
7) The exemplary remote device may contain additional software for reading QR codes.
8) The exemplary remote device 110 may contain additional software for HTML5 rendering, Sensor Integration and Touch screen input.

### Server

In one embodiment the “remote service endpoint” is abbreviated as “server”, and refers to an Internet service point that may be designated by a URL consumable by Internet capable devices. The server 120 may possess one or more of the following elements or features:
1) The exemplary server 120 may interpret a specialized communication protocol as set forth in the claim.
2) The exemplary server 120 interprets standard network communication protocols (HTTP, IP, TCP, Sockets).
3) The exemplary server 120 may send and receive network communication without regard to its underlying operating systems (e.g., Linux, Windows).
4) The exemplary server 120 may send and receive network communication without regard to its underlying hardware (e.g., Virtualized servers, Cloud computing, or physical servers that are connected to the Internet).
5) The exemplary server 120 may send and receive network communication without regard to its underlying network infrastructure (e.g., load balancing, content distribution networks, specific IP address, domain name resolution, network routing equipment, wired or wireless network connection, etc).

### Basic System Implementation

This section describes various details association with a particular exemplary implementation of an embodiment of the remotely interactive display system described herein.
1) Install a web server software (such as, for example, an apache Web server) on a server 120 connected to the Internet.
2) Build two HTML pages (a mobile page and a screen page) as a Web application. The page includes UI elements in HTML code, application logic in Javascript code, and the Javascript API for virtual channels 142, 144, 146.
3) The display device 130 preferably runs HTML rendering software, which loads the screen page and activates the API for virtual channel 146. The API informs the display device 130 of the Unique ID and mobile page URL, which is sent from the server 120. A QR code is displayed on the screen 154 based on the ID and URL.
4) The user uses QR scanning software on a remote device 110 to scan the QR code on the screen 154 of display device 130, and the QR code is interpreted as a URL with the ID parameter embedded in the QR code.
5) The remote device 110 opens a Web browser pointing to the mobile page, which will activate the API for the virtual channel 142.
6) The API talks to the server 120 with the ID it retrieved from the URL, which sets up a virtual connection to the display device 130.
7) The mobile HTML page contains a text input box.
8) When user inputs text into the box, it triggers a Javascript function call, which will invoke the API to send message data to the virtual channel. The server 120 will relay the message data to the API of the display device 130.
9) The display device 130 receives the message data, and renders it on the HTML page presented by the screen 154 in a page element.

In this way once a channel has established, basic interactivity between a remote device 110 and the display device 130 can be achieved. In the above example, a text input on the remote device 110 can form the basis of a message sent to the device 130. The message is relayed from the remote device 110, to the server 120, and finally to the display device 130, where the message then appears on the screen 154.

Once a communication channel has been established between a remote device 110 and the display device 130 in, for example, the manner set forth above, more complex forms of interaction can be developed through practices commonly known by those skilled in the art. The following section presents some additional examples of more complex interactions that can be produced through using the exemplary remotely interactive system.

### Exemplary System Applications

### Touch-Activated Remote Control Presentation/Photo Viewer

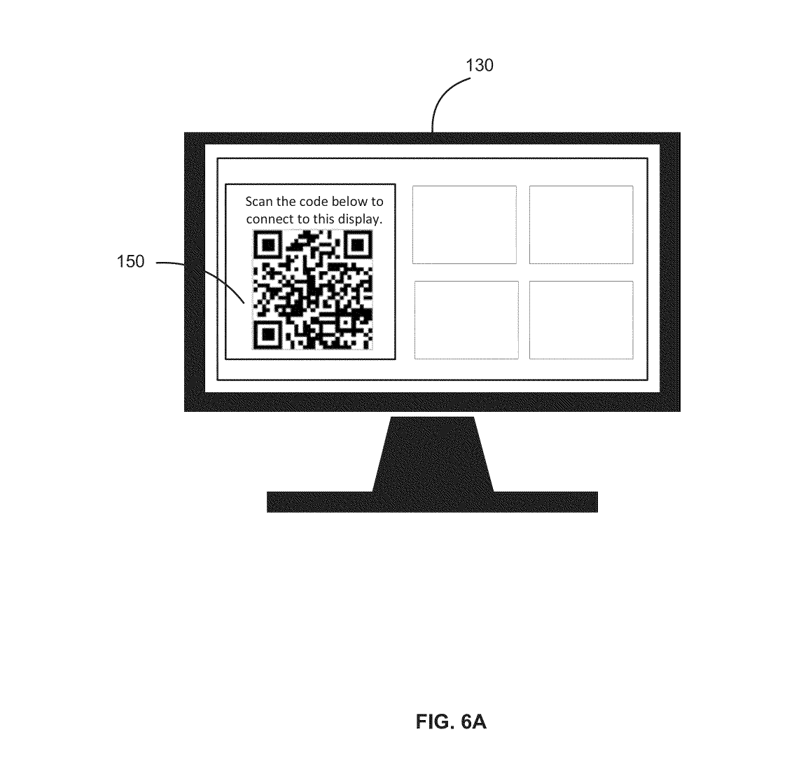

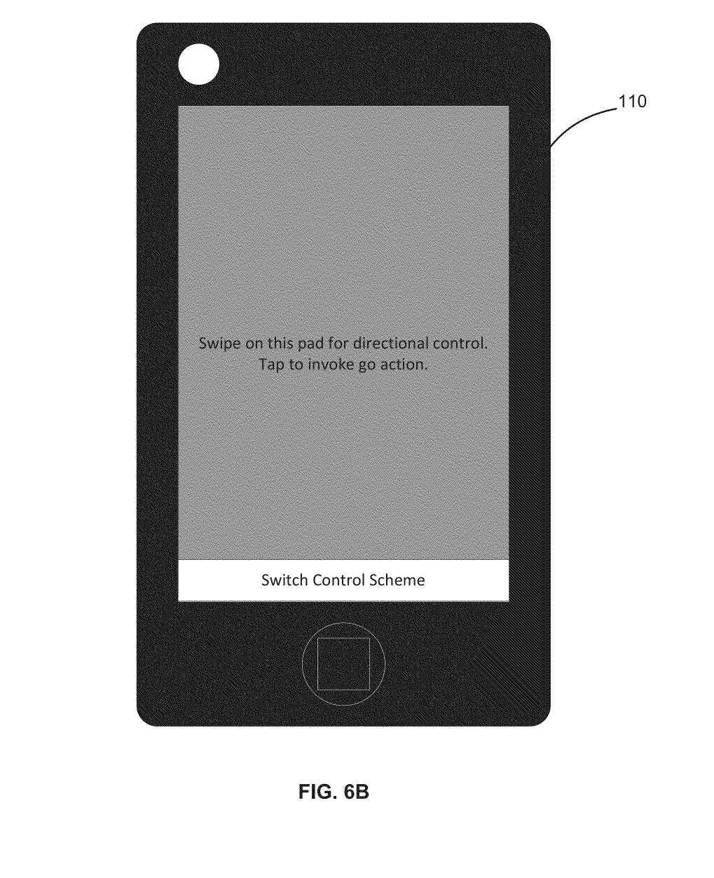

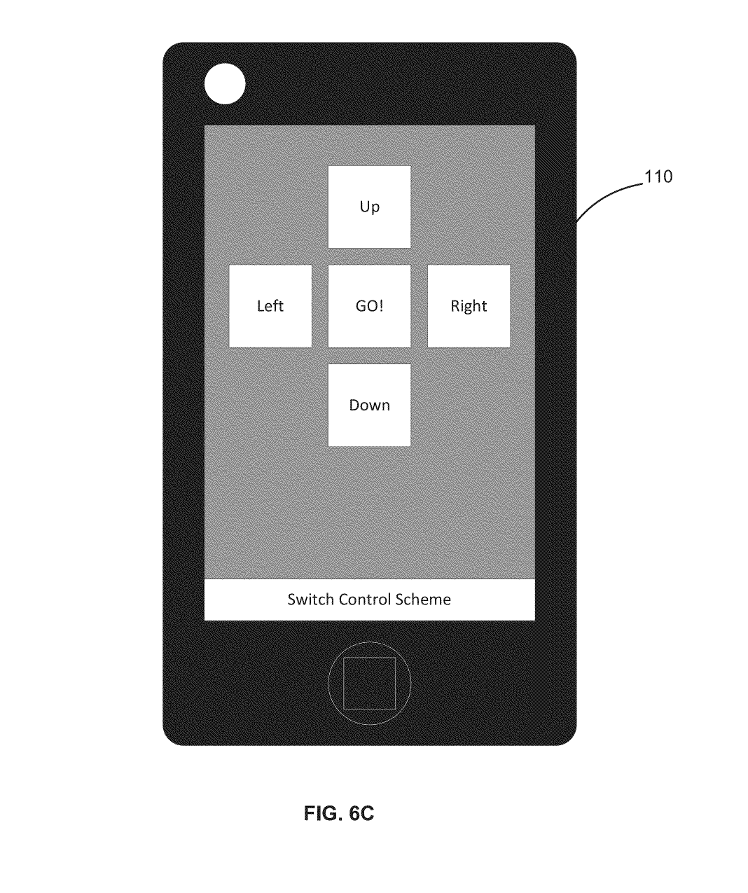

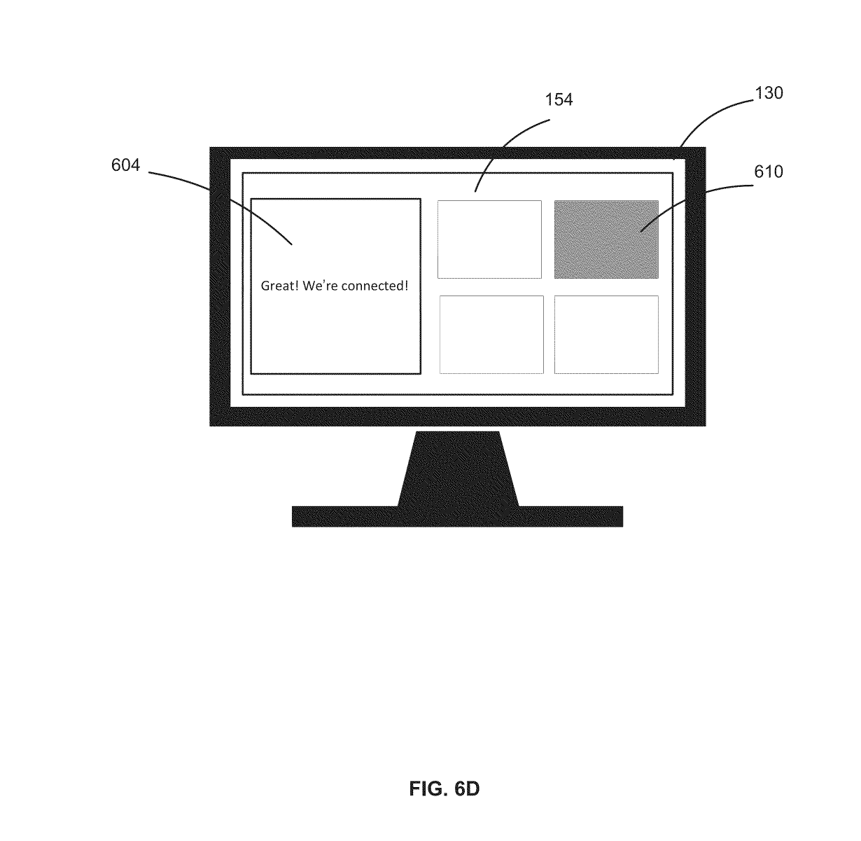

Attention is now directed to FIGS. 6A-6D, which collectively illustrate aspects of a touch-activated remote control presentation and photo viewer application implemented by the remotely interactive display system of the disclosure. As shown in FIG. 6A, in an unconnected state the display device 130 presents the unique pairing code as both an embedded 2D barcode (QR code) and a URL string, alongside distinguishing content enabling the user to interpret the display as a presentation device (in this case, a summary of different types of content available).

Turning now to FIG. 6B, an illustration is provided of a remote device 110 displaying a touchpad controller. When the remote device 110 connects to the service point, i.e., server 120, provided by the unique pairing code, and the connection has been established, the user may swipe the screen (through touch input features) or press directional command buttons, which relays the direction or “activate” command through the web server to the host display device 130. FIG. 6C depicts the remote device 110 displaying a control pad/directional command button controller through which such directional commands may be entered.

As shown in FIG. 6D, when the host display device 130 receives the direction or “activate” commands, the display screen 154 is updated according to the appropriate response to the command (move to another content box, scroll to another image or content slide, or invoke an action to load other contents). In particular, FIG. 6D shows that the screen 154, through display pane 604, has indicated that a remote device 110 has been connected to the display device 130 and that a user of the remote device 120 has swiped or pressed directional arrows to highlight a top right box 610.

### Motion-Activated Remote Control Game

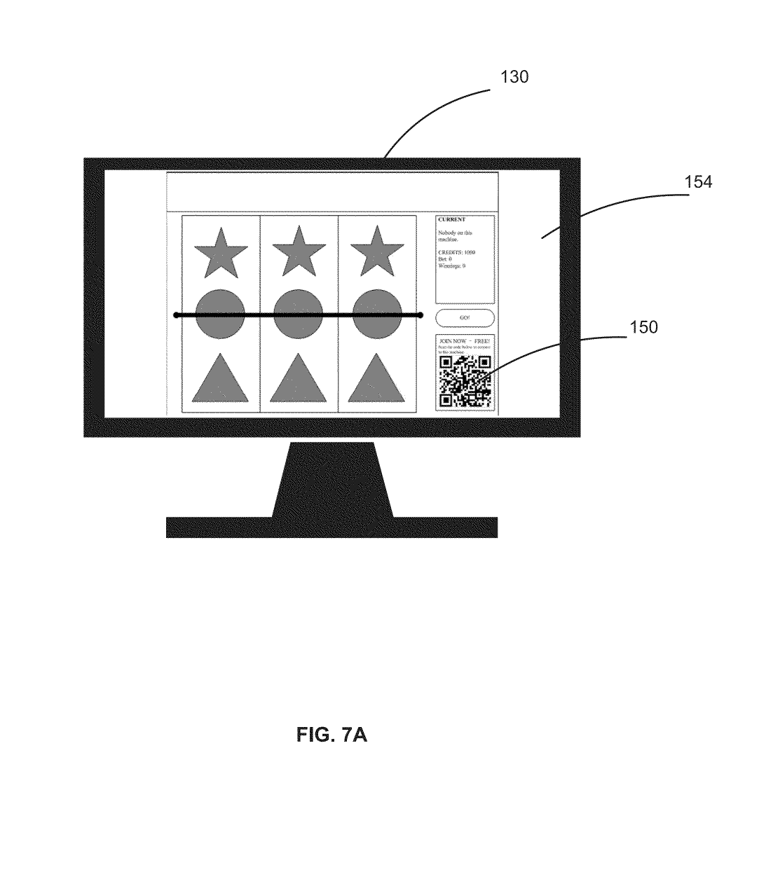

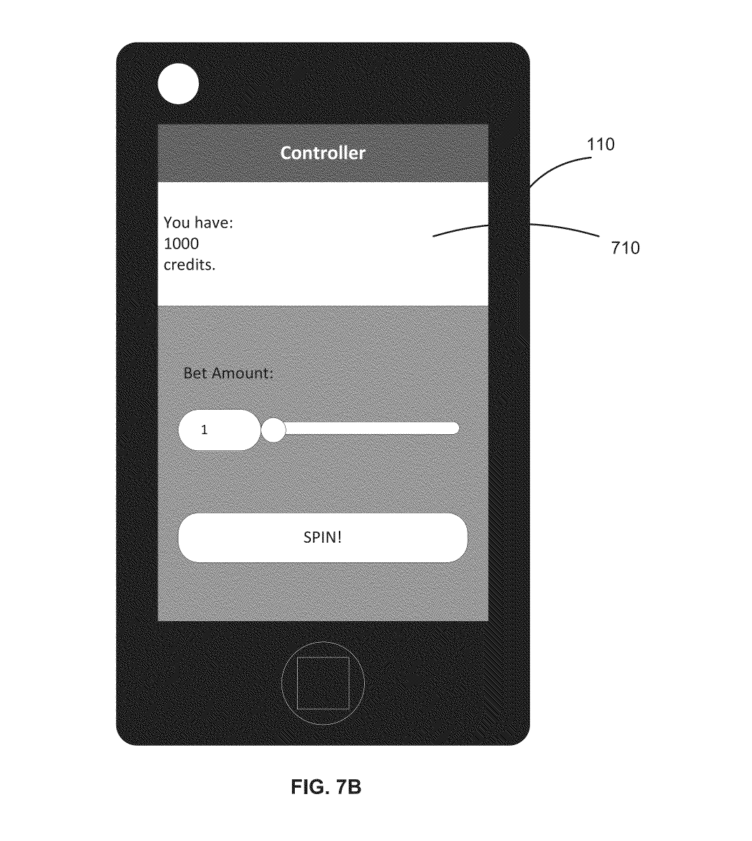

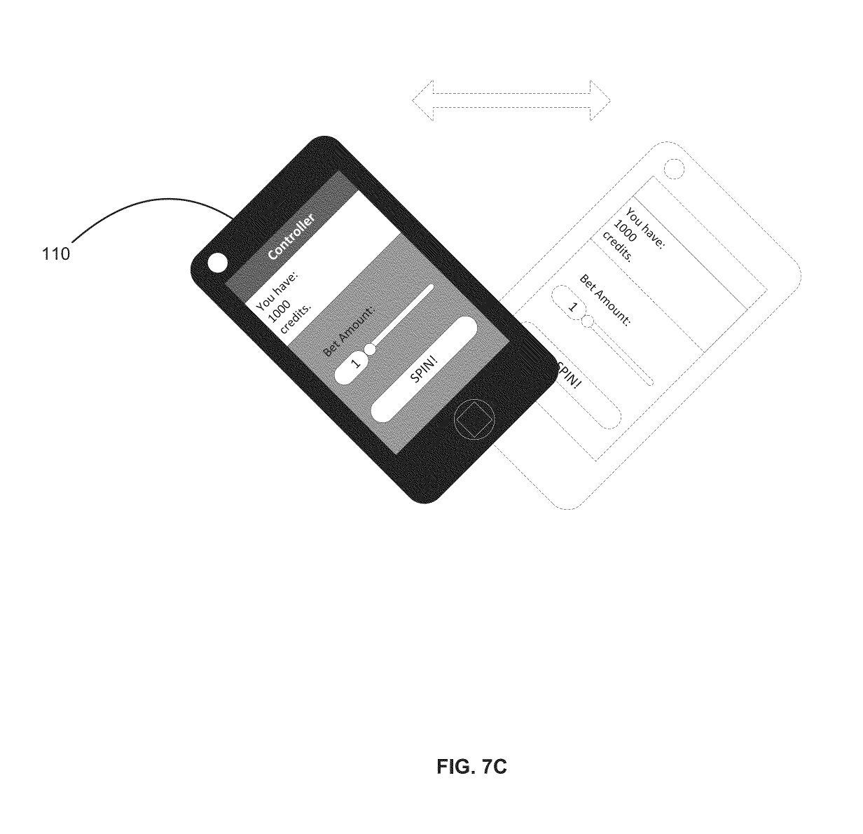

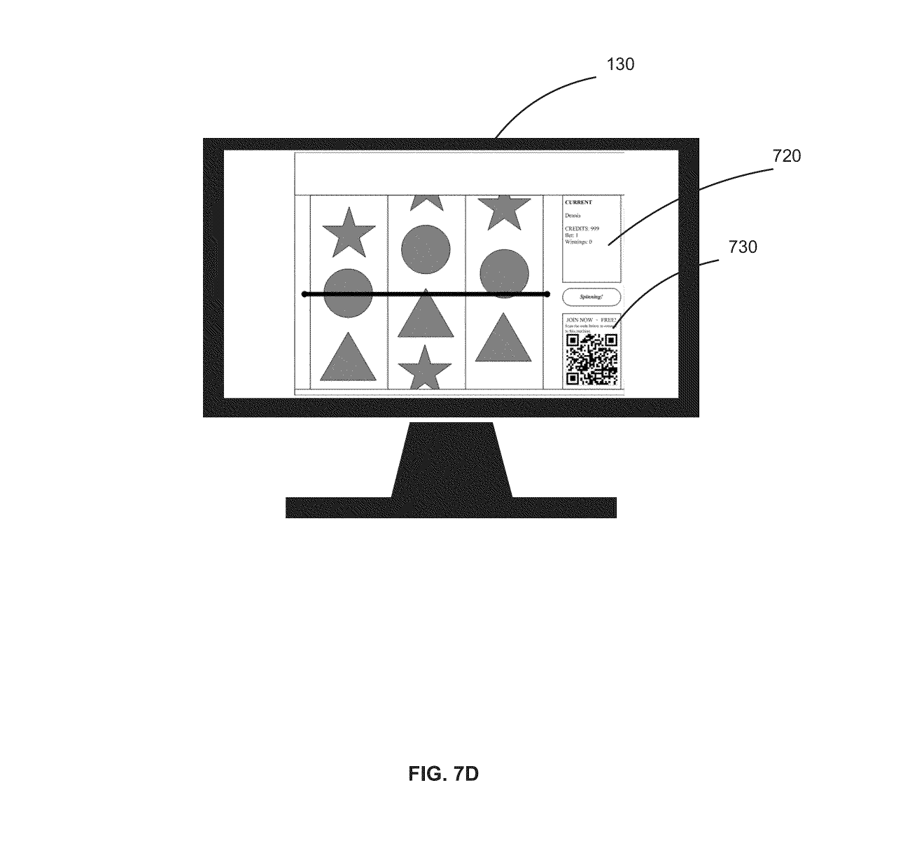

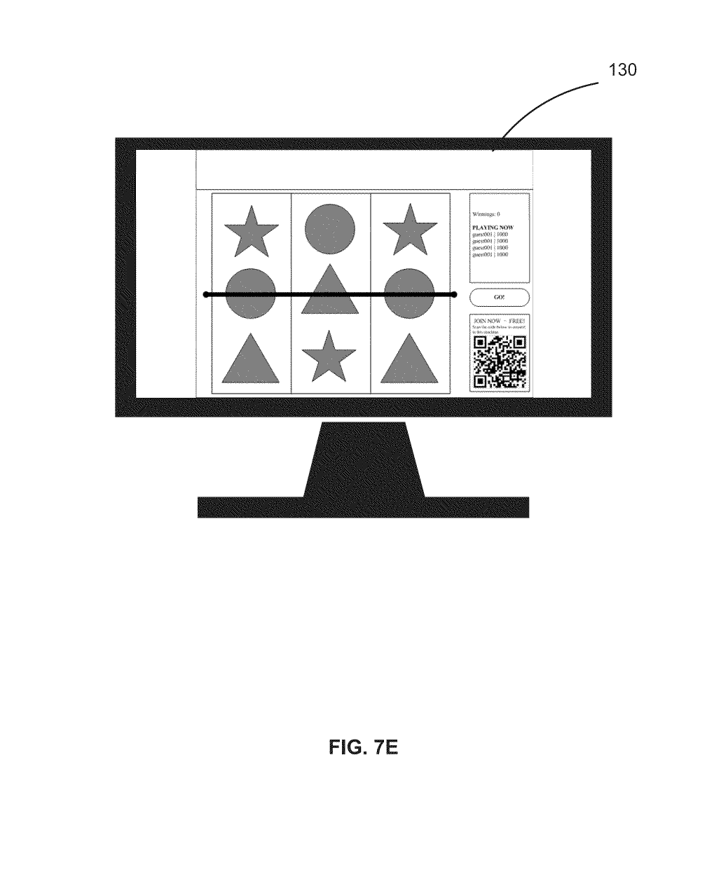

Attention is now directed to FIGS. 7A-7E, which collectively illustrate aspects of a motion-controlled game application implemented by the remotely interactive display system of the disclosure. The host display device 130 uses a browser to visit the third-party website to show the application; in this case, a slot machine. As shown in FIG. 7A, in an unconnected state the screen 154 of the display device 130 presents the unique pairing code 150 as both an embedded 2D barcode (QR code) and a URL string, alongside distinguishing content enabling the user to interpret the display as a game device (in this case, a slot machine).

FIG. 7B illustrates a controller 710 displayed by the remote device 110. As shown, the displayed controller 710 presents information concerning a current credit amount, the ability to set the bet amount, and a button for “Spin” to activate a “slot machine” presented by the display device 130. The user may also use components of the controller, such as a UI slider, to send information such as bet amounts, or text input fields to provide user name.

Referring to FIG. 7C, in the embodiment of FIG. 7 the device 110 includes a motion detector; accordingly, when the device 110 is shaken as indicated by FIG. 7C, an activate command can be sent to the display device 130 via the server 120. Alternatively, the user could be prompted to press or otherwise select a displayed or physical button in order to produce the “activate” command.

Referring to FIG. 7D, an illustration is provided of the display device 130 in its connected state; that is, when a remote device 110 has connected to the server 120 identified by the unique pairing code 150, and the connection has been established. As shown, in this case the screen 154 presents connected user information 720 and a selectable option 730 for more players to join. Having just received the “activate” command from the remote device 110, the reels of the “slot machine” presented by the display device 130 are seen to be in the process of spinning. When users of other remote devices 110 scan the QR corresponding to the option to join 730, the server 120 may permit multiple players to “spin” or otherwise interact with the slot machine presented by the display device (e.g., by permitting each connected user to take a turn activating displayed slot machine). FIG. 7E depicts an exemplary screen which may be presented by the display device 130 when multi-player mode has been enabled.

### Motion-Activated Remote Control 3D Model Viewer

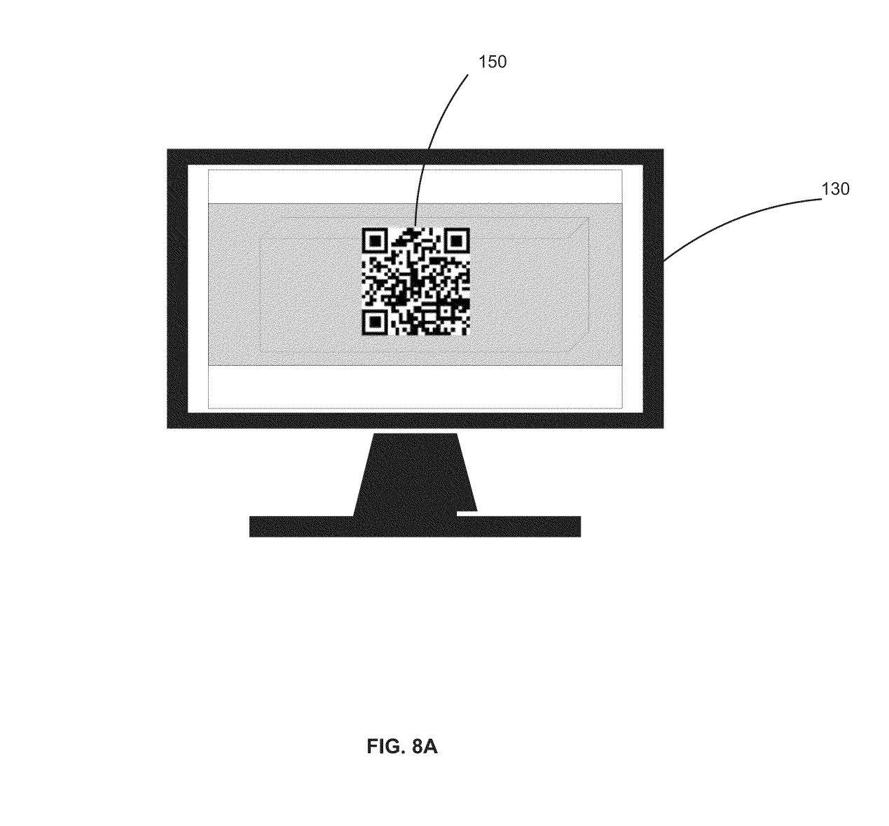

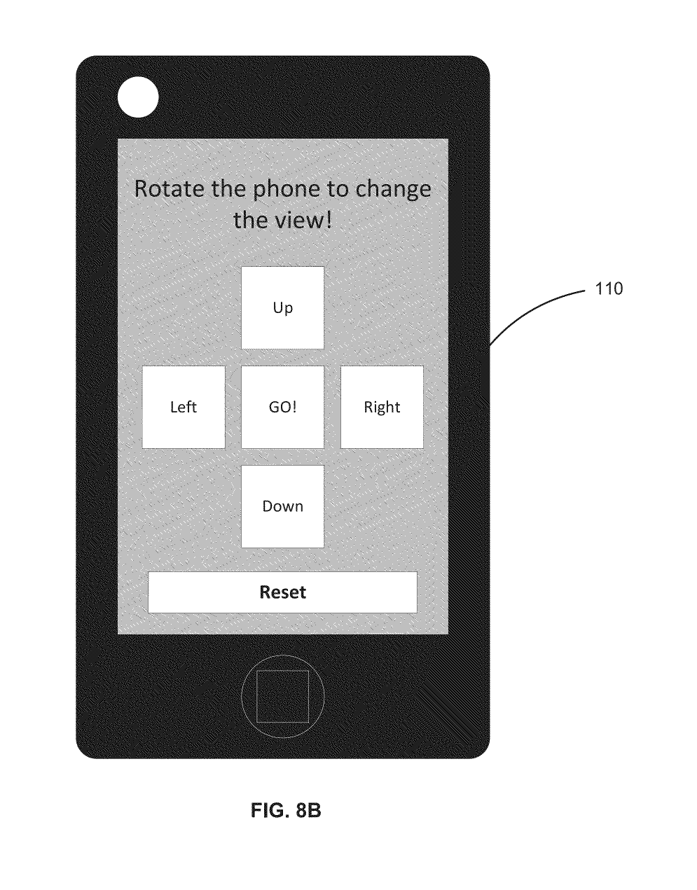

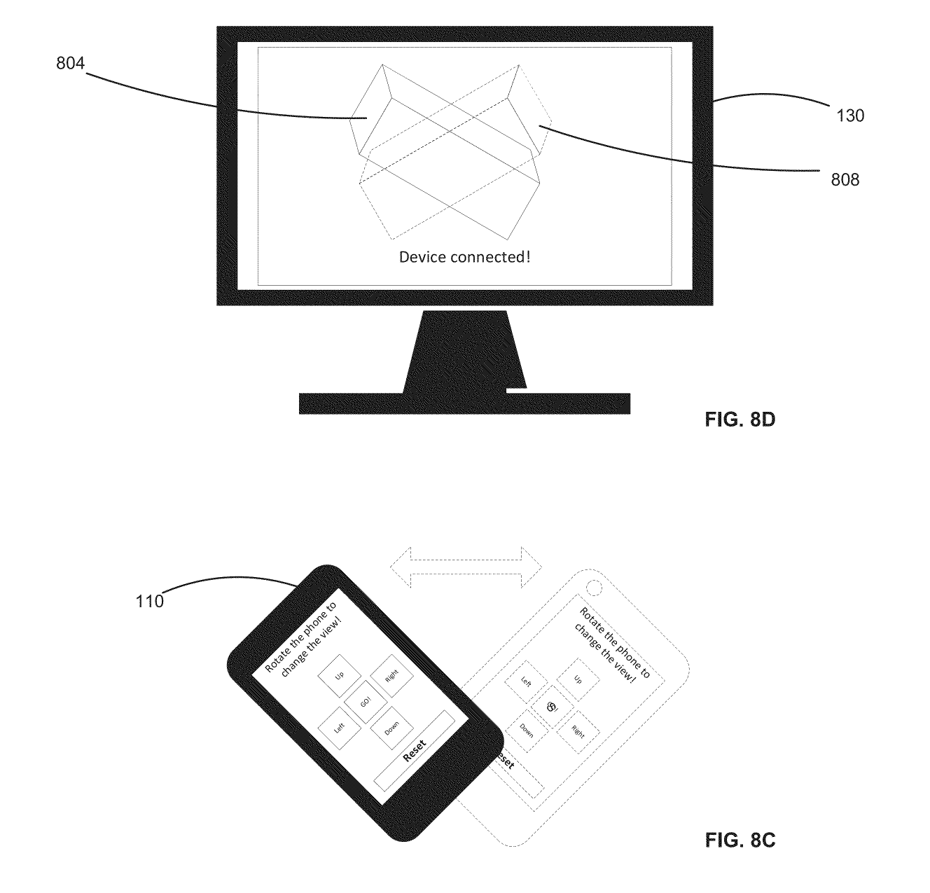

Attention is now directed to FIGS. 8A-8D, which collectively illustrate aspects of a motion-activated remote control 3D model viewer application implemented by the remotely interactive display system of the disclosure. Referring to FIG. 8A, in an unconnected state the host display device 130 may present the unique pairing code 150 as both an embedded 2D barcode (QR code) and a URL string (not shown), alongside distinguishing content enabling the user to interpret the display device 130 as a remotely interactive display.

As shown in FIGS. 8B and 8C, when a remote device 110 connects to the server 120 provided by the unique pairing code, and the connection has been established, the user may rotate the device (through motion detection features) which relays the orientation data through the server 120 to the host display device 130.

As shown in FIG. 8D, upon receiving the updated orientation data through the server 120, the display device transitions an original view 804 of the 3D model into a newly-oriented view 808 of the 3D model.

### CONCLUSION

Disclosed herein is a method and system which enables one or more users to interact with a common display using remote communication devices such as, for example, smartphones and tablets. In exemplary embodiments this interaction is facilitated as follows:
1. Using a standard web browser application or a specialized application with web browsing or network connection capabilities, and using standard Internet protocols, a display device establishes a network connection to a server.
2. The server generates a unique pairing code based on the time the connection is established or a pairing request is made.
3. The server sends the pairing code, in addition to the application content and logic, to the display device.
4. The display device interprets the application content and logic, embeds the pairing code as a URL, and renders the URL as a human-readable text string or a URL-encoded QR code.
5. A remote device loads an application which uses QR decoding software to extract the URL from the QR code displayed on the display device, or uses an embedded web browser and standard user input methods to input the human-readable text string displayed on the display device.
6. The remote device establishes a network connection to the server, using standard Internet protocols.
7. The remote device sends the extracted pairing code from the URL to the server, effectively requesting an Internet-relayed communication channel to the display device.
8. The server sends a message to the display device, notifying the display device that a communication channel has been established with the remote device.
9. The display device receiving the notification will mark the channel as connected, and calls a software interface of the application running on the display device, where the application will decide the next step, which could be:
   a) removing the QR code and text string from the display and changing to a user controlled screen.
   b) continue displaying pairing code or request a new unique pairing code from the server so that another user could repeat the procedure and enable a multiple user application.
10. The display device and the remote device are able to conduct two-way communication, through application level messages relayed by server.
11. Multiple remote devices may join into the communication network established by the server by repeating the procedure above, where any capable device already in the established network may also act as additional display devices.

In the system described above, a specialized communication protocol may be enabled by the server, which may provide one or more of the following functions:
a) Receive a registration request from a display device.
b) Issue a unique ID to the display device.
c) Receive a connection request from a remote device with the unique ID given to the display device.
d) Use the unique ID to associate the display device and the remote device.
e) Provide notification to both the display device and the remote device that the communication channel has been established.
f) If a connection is broken between a display device and the server, other devices in the communication network are notified the connection channel was broken.
g) If a connection is broken between a remote device and the server, other devices in the communication network are notified the connection channel was broken.
h) Relay a message to other devices in the communication network.

In various embodiments, the remote device directly translates hardware inputs or user control actions (e.g., gestures, typing, motion) into control logic commands which may be used to interact with games, interact with applications, or the like displayed on or with the display device. These control logic commands may be specified at the application level, where the system provides message relay functions between remote and display devices. In some embodiments, the display device may not directly provide translation of control logic, but rather accepts application specified commands, which are sent by the remote. Those skilled in the art will appreciate that in some embodiments, the display device provides translation of control logic.

As the display device, remote device, and/or server may contain all or some of the components for utilizing this system (e.g., computing unit capable of processing application logic, an Internet connection, and software with Internet browsing capabilities), application logic processing may occur on any component, and the roles of display device, and/or remote device may be interchanged freely at the application design level.

In some embodiments, in practical usage of this exemplary system, multiple entry methods may be available to the user:

1) The user may see a display device with an established connection, displaying both QR code and URL string to be interpreted by and connected to by a remote device;
2) The user may have a remote device running an application with the underlying system components, which may prompt the user to set up a display device by visiting a specified URL, and may access the display application from the display device;
3) A remote device may also act as a display device, displaying both QR code and URL string, which will be interpreted by and connected to by another remote device.

In various embodiments, through use of this communication protocol and process, an exemplary system is provided whereby applications may be built enabling communication between display and remote devices through a basic web interface. There are multiple potential use scenarios that may be specified in the application level design, enabling real time communication between display and remote devices in the established network, as suggested in the examples described.

As noted, some embodiments of the present disclosure may include computer software and/or computer hardware/software combinations configured to implement one or more processes or functions associated with the present disclosure such as those described above and/or in the related applications. These embodiments may be in the form of modules implementing functionality in software and/or hardware software combinations. Embodiments may also take the form of a computer storage product with a computer-readable medium having computer code thereon for performing various computer-implemented operations, such as operations related to functionality as described herein. The media and computer code may be those specially designed and constructed for the purposes of the present disclosure, or they may be of the kind well known and available to those having skill in the computer software arts, or they may be a combination of both.

Examples of computer-readable media within the spirit and scope of the present disclosure include, but are not limited to: magnetic media such as hard disks; optical media such as CD-ROMs, DVDs and holographic devices; magneto-optical media; and hardware devices that are specially configured to store and execute program code, such as programmable microcontrollers, application-specific integrated circuits (“ASICs”), programmable logic devices (“PLDs”) and ROM and RAM devices. Examples of computer code may include machine code, such as produced by a compiler, and files containing higher-level code that are executed by a computer using an interpreter. Computer code may be comprised of one or more modules executing a particular process or processes to provide useful results, and the modules may communicate with one another via means known in the art. For example, some embodiments of the disclosure may be implemented using assembly language, Java, C, C#, C++, or other programming languages and software development tools as are known in the art. Other embodiments of the disclosure may be implemented in hardwired circuitry in place of, or in combination with, machine-executable software instructions.

The foregoing description, for purposes of explanation, used specific nomenclature to provide a thorough understanding of the disclosure. However, it will be apparent to one skilled in the art that specific details are not required in order to practice the disclosure. Thus, the foregoing descriptions of specific embodiments of the disclosure are presented for purposes of illustration and description. They are not intended to be exhaustive or to limit the disclosure to the precise forms disclosed; obviously, many modifications and variations are possible in view of the above teachings. The embodiments were chosen and described in order to best explain the principles of the disclosure and its practical applications, they thereby enable others skilled in the art to best utilize the disclosure and various embodiments with various modifications as are suited to the particular use contemplated. It is intended that the following claims and their equivalents define the scope of the disclosed inventions.

What is claimed is:

1. A method, comprising:
receiving a registration request from a display device;
issuing a unique ID to the display device;
receiving a connection request from a remote device with the unique ID given to the display device;
using the unique ID to associate the display device and the remote device;
providing notification to both the display device and the remote device that the communication channel has been established.
